(19) United States
(12) Patent Application Publication
(10) Pub. No.: US 2006/0064598 A1
(43) Pub. Date: Mar. 23, 2006

(54) Illegal access preventing program, apparatus, and method

(75) Inventors: Yoshiki Higashikado, Yokohama (JP); Takayoshi Kurita, Mishima (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/146,152

(22) Filed: Jun. 7, 2005

(30) Foreign Application Priority Data
Jun. 9, 2004 (JP) 2004-171486

(51) Int. Cl. H04L 9/00

(52) U.S. Cl. 713/182

(57) ABSTRACT

An unauthorized or illegal access preventing system implementing security procedures to an application layer without having to rely on business applications of an application server having a web container. The illegal or unauthorized access supervising system includes an operation describing file storing operation sequence of a normal operation of a business application, a web container as the execution base of a plurality of business applications, an inspection log function provided to the web container to acquire an operation log of the business applications, and an application supervising function executing an operation in accordance with a comparison result by comparing, with reference to the log stored in the inspection log function, the operation sequence of the business applications of the web container with the operation sequence of the normal operation stored in the operation describing file.

### CROSS-REFERENCE TO RELATED APPLICATION

This application is related to and claims the benefit of Japanese Patent Application No. 2004-171486, filed Jun. 9, 2004, in Japan, the disclosure of which is incorporated herein by reference.

### BACKGROUND OF THE INVENTION

1. Field of the Invention

The present invention relates to a technology for preventing illegal or unauthorized access to a server that is connected with a network.

2. Description of the Related Art

In recent years, computers are generally connected to networks, such as, intranets set up in enterprises and the Internet using connections provided by various service providers.

Accordingly, the network established by enterprises, such as a LAN, etc., is often connected with the Internet, and apparatuses connected with the LAN also communicate with servers on other networks via the Internet.

According to the situation described above, access to the internal side of the network from the external side is also allowed. As a result, a system that is accessible from external systems is always at risk of access to the parts other than parts which should be accessed from the external side of network, namely with the risk of illegal or unauthorized access.

Therefore, it is generally common to provide a router or a host to prevent illegal access from the external side, such as by providing a firewall for a connecting point, which the other networks use to access the system, to prevent unauthorized access from unauthorized external network systems.

A firewall generally has a function of reading various information pieces of packets to be transmitted (for example, transmission destination IP address, transmission source IP address, option information, etc.,), and preventing transmission of the packets to an address which should not be accessed (for example, packet filtering), etc.

In recent years, commercial services, also called e-Businesses, which are provided using the Internet are rapidly spreading, thereby causing the spread of such networks. Web services are generally realized when users conduct various types of communications and engage in information exchange with a server by extending the connection with the server provided on the network in the side of providing services. Generally, the Web services represented by such e-Businesses are executed using protocols such as HTTP (Hyper Text Transfer Protocol) and HTTPS (Hyper Text Transfer Protocol Security). However, these protocols are used in the session layer located in a higher level of the network layer (hierarchically) for management of packets. Further, it is impossible to discriminate content of a packet based on the protocols by monitoring a divided packet of data.

Therefore, contents described using the HTTP and HTTPS protocols cannot be discriminated or differentiated with a firewall provided for filtering packets of data. Moreover, if the request described using the HTTP and HTTPS protocols includes the risk of illegal or unauthorized access, this request would be transmitted through the firewall.

As a method for solving the problems described above, an apparatus called an appliance apparatus has been provided between object servers and networks. The appliance apparatus integrates packets to enable access to the servers, analyzes incoming accesses based on the HTTP and HTTPS protocols, and transfers the packets to the servers upon verification that the relevant access is not an illegal or unauthorized access.

However, sophistication of Web services will continue to generate various types of businesses, for example, search of goods, etc., corresponding to users' requests for http and https protocols. Accordingly, application servers including the business applications corresponding to such businesses have been proposed.

FIG. 13 illustrates a typical configuration of an application server system. As illustrated in FIG. 13, a firewall 103 and an appliance apparatus 104 are provided between an application server 101 for providing the actual services and the Internet 102, and the packets coming from the Internet 102 are transmitted to the application server 101 via the firewall 103 and the appliance apparatus 104. As described above, communication to the application server 101 from the Internet 102 is performed in units of packets using the firewall 103. Moreover, the appliance apparatus 104 checks illegal or unauthorized access in the HTTP layer level. As a result, only the packet/request which is assumed to be authorized or not to be illegal is transmitted to the application server 101. In addition, the application server 101 includes an HTTP server function 1001 to accept the Web service request and to transmit the result responsive to the request to the requesting side, and the application function 1002 executes the actual process in relation to the request accepted by the HTTP server function 1001. Moreover, the application function 1002 includes various business applications 1011 through 1015, and a Web container 1016 that distributes, as the execution basis of these applications, the requests accepted by the HTTP to the business applications 1011 through 1015 as required and returns the results of the business applications 1011 through 1015 to the HTTP after conversion into the HTML format. In addition, although not illustrated, a database server may be connected with the application server 101 in order to allow search of the database used by the business application, as required.

In the system described above, the applications for controlling displays based on analysis of the HTTP protocol called the Web browser are installed in a computer for issuing a request, and users can therefore issue the request to the application server 101 via the Internet 102 using this Web browser. As a result, assuming that communication to the application server 101 from the Internet 102 is performed in unit of packets via the firewall 103 and checking for unauthorized or illegal access in the HTTP layer level is conducted to verify the normal access in the appliance apparatus 104, only the packet/request is transmitted to the application server 101. The HTTP server function 1001 within the application server 101 receives this information and transfers the request to the application function 1002. The Web container 1016 within the application function 1002 receives this request and transfers the request to the business application in accordance with this request.

Thereafter, when the process by the business application to which the request is transferred is completed, the business application transfers the request to the Web container 1016, which converts the request to the HTTP protocol and transfers the result to the HTTP server function 1001.

The HTTP server function 1001 receives the HTML and returns the result with the HTTP protocol to the computer that issued the request via the appliance apparatus 104, firewall 103 and the Internet 102. Further, the result information is received by the computer that issued the request and is then displayed on the Web browser.

In accordance with the Web service utilizing such an application server, not only an image display request by the HTTP protocol is generated but also processes by each business application are generated or executed based on the request. Therefore, even when a check for the HTTP protocol is performed by providing the appliance apparatus 104, it is impossible to check for an illegal or unauthorized access to the business application.

Accordingly, security for the business application has been implemented using software of the application and using correction techniques (i.e., a patch) of the software created by developers and providers of such application software.

As can be understood from FIG. 13, because a plurality of business applications are installed on a Web container 1016, when security is required only for the business applications as in the case of the typical system, extensive security must be provided to these business applications.

Further, as services of the business applications continue to be diversified and each business application performs complicated application processes, such security must be provided by developers having a high level of skill.

In addition, the environment for executing a plurality of business applications of the Web container 1016 provided as the common base may be developed by any developer or provider in the environment to thereby develop the applications which can be executed on the Web container 1016. Moreover, in a case where a plurality of applications are installed to execute complicated processes, these applications are not often developed by the same developer or provider. Accordingly, the business applications by a plurality of developers or providers are generally executed in parallel, thereby causing quality management for security of each business application to be difficult.

Therefore, there is a need for a system that detects an illegal or unauthorized access and that can easily and comprehensively detect an illegal or unauthorized access in an application level of an application server in which a plurality of business applications are operating on a common basis, such as a Web container.

### BRIEF DESCRIPTION OF THE INVENTION

According to an aspect of the present invention, an operation describing file storing an operation sequence during normal operations of business applications is provided. Further, a supervising log is provided in a container to acquire operation logs of the business applications, and an application supervising function is provided to conduct processes in accordance with a comparison result by comparing the operation sequence of the business applications on the container with the operation sequence during the normal operations stored in the operation describing file with reference to the logs stored in the supervising log.

Moreover, according to another aspect of the present invention there is provided, a rule file storing irregular operation sequence for input/output operations, a supervising log for storing a log of input to or of output from the container, and an input/output supervising device to conduct the processes in accordance with a comparison result by comparing the input/output operation sequence of the container with irregular operation sequence recorded in the rule file.

Accordingly, an aspect of the present invention provides an illegal access detecting system which enables a mechanism of measuring illegal access to the container, and therefore can easily and comprehensively detect illegal access of the application level without requiring a measure for illegal access to the business application itself.

Additional aspects and/or advantages of the invention will be set forth in part in the description which follows and, in part, will be obvious from the description, or may be learned by practice of the invention.

### BRIEF DESCRIPTION OF THE DRAWINGS

FIG. 1 Illustrates a structure of an illegal access preventing system, according to an aspect of the present invention.

FIG. 2 Illustrates operations of an application supervising function, according to an aspect of the present invention.

FIG. 3(a)-(d) Illustrates log information acquired by each inspection log function, according to an aspect of the present invention.

FIG. 4 Illustrates integrated log information generated with an application supervising function by integrating log information recorded with each inspection log function, according to an aspect of the present invention.

FIG. 5 Illustrates rule information stored in an operation describing file, according to an aspect of the present invention.

FIG. 6 Illustrates an input/output supervising function, according to an aspect of the present invention.

FIG. 7 Illustrates an illegal access preventing system of a Java™ (registered trade mark) system, according to an aspect of the present invention.

FIG. 8 Illustrates an inspection operation for an input HTTP request issued by an input/output supervising mechanism, according to an aspect of the present invention.

FIG. 9 Illustrates an example of an alternative operation executed in an inspection function for an input HTTP request executed by the input/output supervising mechanism, according to an aspect of the present invention.

FIG. 10 Illustrates a flowchart of an inspection operation for an output HTTP response executed by the input/output supervising mechanism, according to an aspect of the present invention.

FIG. 11 Illustrates an application supervising operation executed by an execution supervising monitor, according to an aspect of the present invention.

FIG. 12 Illustrates an example of an application supervising operation executed by an execution supervising monitor, according to an aspect of the present invention.

FIG. 13 Illustrates a typical structure of an illegal supervising system.

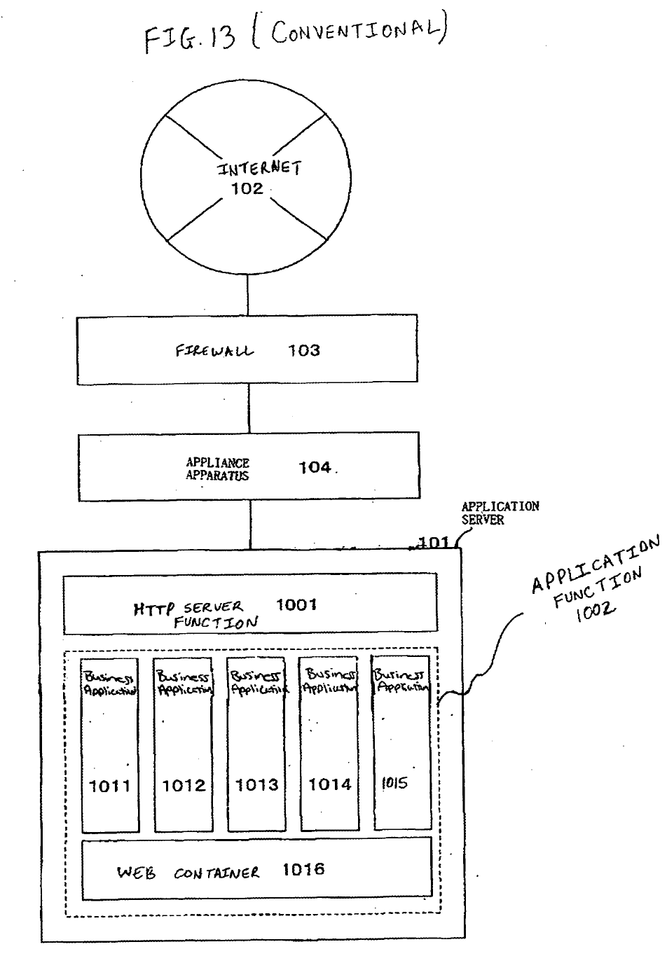

### DETAILED DESCRIPTION OF THE PREFERRED EMBODIMENTS

Reference will now be made in detail to the present invention, examples of which are illustrated in the accompanying drawings.

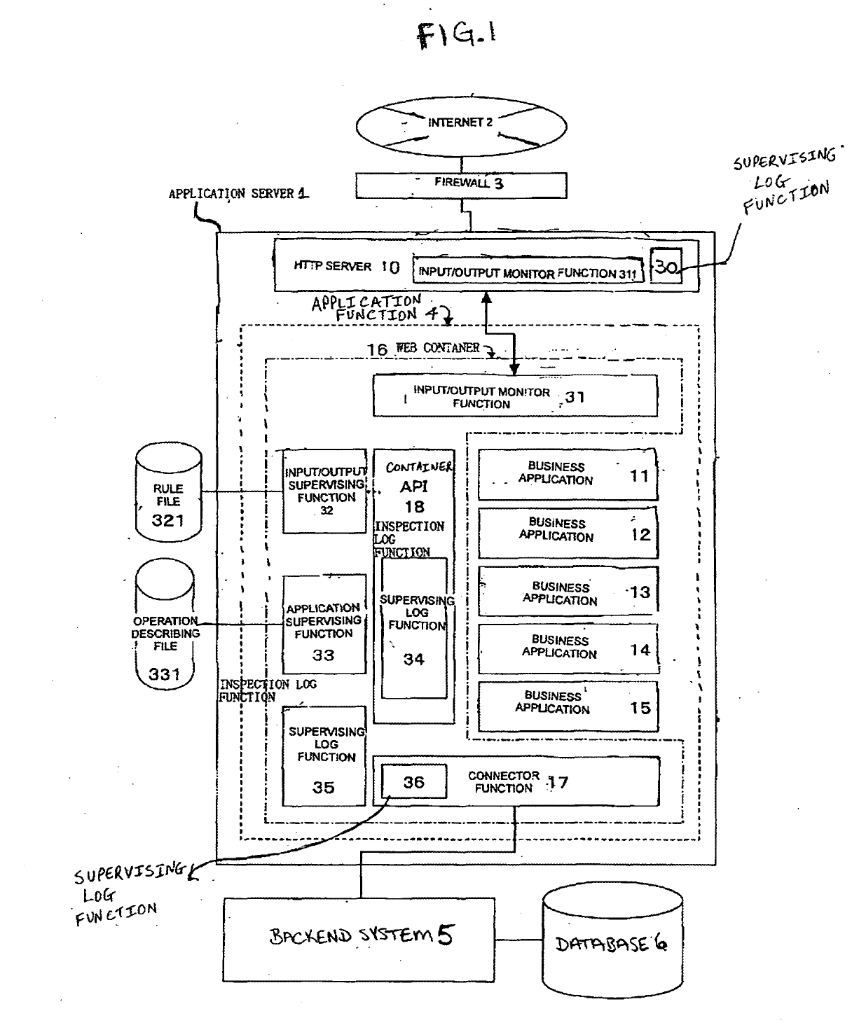

FIG. 1 is a system structure diagram illustrating an illegal or unauthorized access detecting system according to an aspect of the present invention.

In FIG. 1, numeral 1 denotes an application server 1 that is connected with the Internet 2 via a firewall 3. The Internet 2 and the firewall 3 have a similar structure to the typical system described above and therefore description thereof is omitted.

The application server 1 is provided with an HTTP server 10 and an application function 4. Moreover, the application function 4 is provided with business applications 11 through 15 and a Web container 16 which is used as the execution base of the business applications 11 through 15.

The Web container 16 includes a container API 18 for storing the applicable functions and instructions to call and execute the functions and instructions from the business applications 11 through 15 via the Web container 16. Moreover, the HTTP sever 10 comprises an input/output function 311 for monitoring information pieces, such as time information, transmitting source, and address (destination) of the information, of a request received via the firewall 3, for example, and a supervising log function 30 for recording the monitored information. In addition, the Web container 16 of FIG. 1 is provided with an input/output monitoring function 31 monitoring an output from the Web container 16, a connector function 17 communicating with a backend system 5 that is provided with a search function of a database 6, and a supervising log function 36 recording history of the information by monitoring the information inputted or outputted via connector function 17.

The backend system 5 is used, for example, when a request is based on a search result of the database 6, when the application function 4 sends a search request to the backend system 5 with the connector function 17 and the backend system 5 receives the search request and executes a search process using the database 6, and the application function 4 receives the result of the search via the connector function 17.

Further, the Web container 16 includes a supervising log function 35 for acquiring a log of re-processing contents when the web container 16 has operated the applications, and a supervising log function 34 for acquiring a log of the output timing of the functions called by the container API 18. In addition, the Web container 16 also includes an application supervising function 33 for supervising whether the application is matched with the process recorded in the operation describing file 331 by acquiring and integrating the logs recorded in the log supervising function, and an input/output supervising function 32 for supervising whether the input/output is matched with the process recorded in the rule file 331 by acquiring and integrating the logs recorded in the log supervising function.

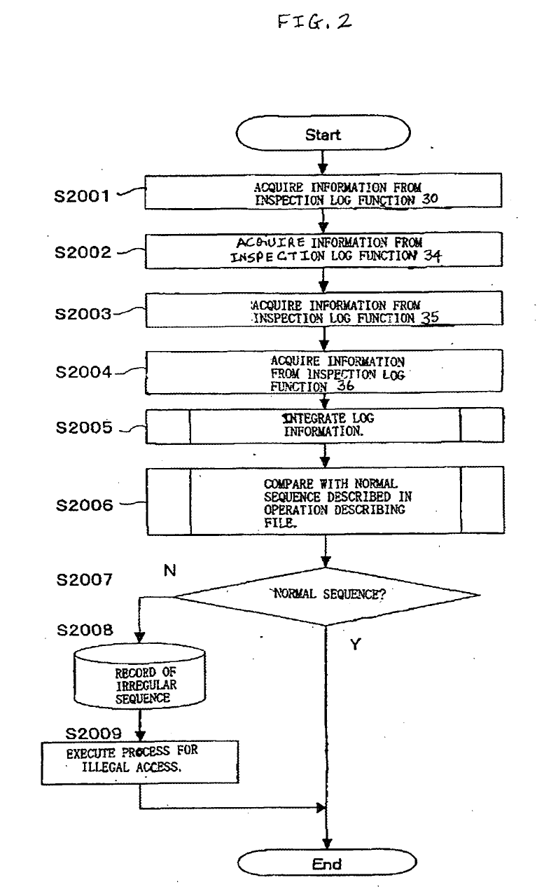

Operations of the illegal or unauthorized access preventing system structured as described above will be described further with reference to the flowchart of FIG. 2. Operations in FIG. 2, unless otherwise described particularly, are conducted by the application supervising function 33 of the web container 16 (shown in FIG. 1).

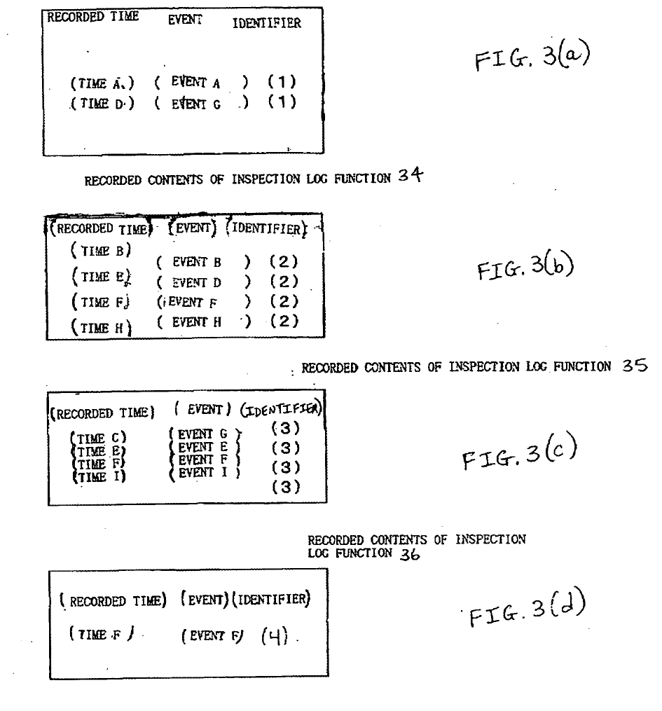

The supervising log functions 30, 34, 35, 36 (shown in FIG. 1) correspondingly record object information, as needed. The supervising log function 30 records input/output logs of the HTTP server 10 with the input/output monitoring function 311 as described above in relation to FIG. 1. An example of this log is illustrated in FIG. 3(a). Accordingly, the log includes, the log recording time, an event conducted at the recorded time, an identifier (1) indicative of the recording by the supervising log function 30, etc. Moreover, the supervising log function 34 records a log for calling functions and instructions of the container API 18 as described above in relation to FIG. 1. An example of this log is illustrated in FIG. 3(b). The log includes, the log recording time, an event conducted at the recorded time, an identifier (2) indicating the recording by the supervising log function 34, etc. Moreover, the supervising log function 35 records logs by supervising the business applications of the web container 16 as described above. An example of this log is illustrated in FIG. 3(c). This log includes, the log recording time, an event conducted at the recorded time, an identifier (3) indicating the recording by the supervising log function 35, etc. In addition, the supervising log function 36 records logs by supervising input and output for the backend system 5 with the connector function 17 as described above in relation to FIG. 1. An example of this log is illustrated in FIG. 3(d). This log includes, the log recording time, an event conducted at the recorded time, an identifier (4) indicating the recording by the supervising log function 36, etc.

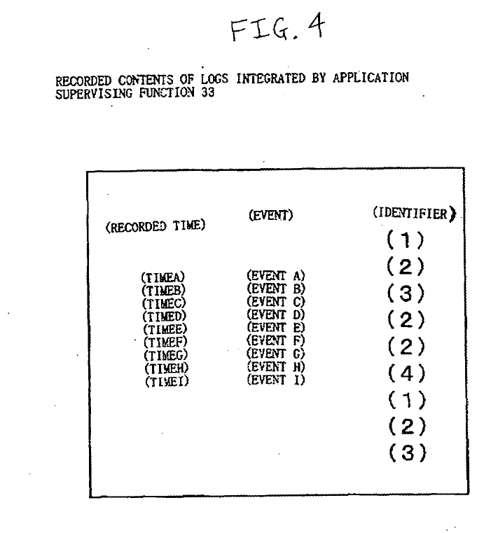

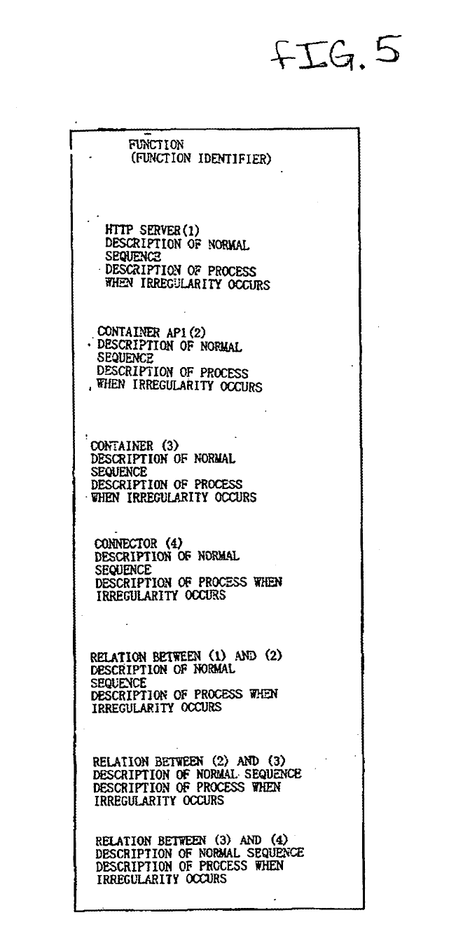

The application supervising function 33 (shown in FIG. 1) acquires the log information stored in the log supervising functions 30, 34, 35, and 36 (operations S2001 through S2004 in FIG. 2). The application supervising function 33 integrates the acquired log information in the sequence of time (operation S2005). An example of the integrated log information is illustrated in FIG. 4. Next, the application supervising function 33 compares the integrated log information with normal operation sequence information stored in the operation describing file 331 (operation S2006) to judge whether the process of the application function 4 is based on the normal sequence (operation S2007). Exemplary recorded contents of the operation describing file 331 used in this case are illustrated in FIG. 5.

As described above, definition of the normal sequence and description of output contents outputted as irregular sequence when it is not based on the normal sequence are recorded in pairs within the operation describing file 331. Accordingly, when determining that the definition is based on the normal sequence, the operation is complete completed. When the operation is not based on the normal sequence, the application supervising function 33 records occurrence of the irregular sequence (operation S2008) and outputs content corresponding to the irregular sequence recorded in the operation describing file 331 is outputted (operation S2009). The output may be printing, notifying a terminal of an administrator of the application server 1, or displaying on a display screen, etc. According to an aspect of the present invention, irregular operation of an application by illegal or unauthorized access is be prevented by returning to the application condition before occurrence of the irregular operation or by stopping the calling of the container API in accordance with detection of an irregular sequence.

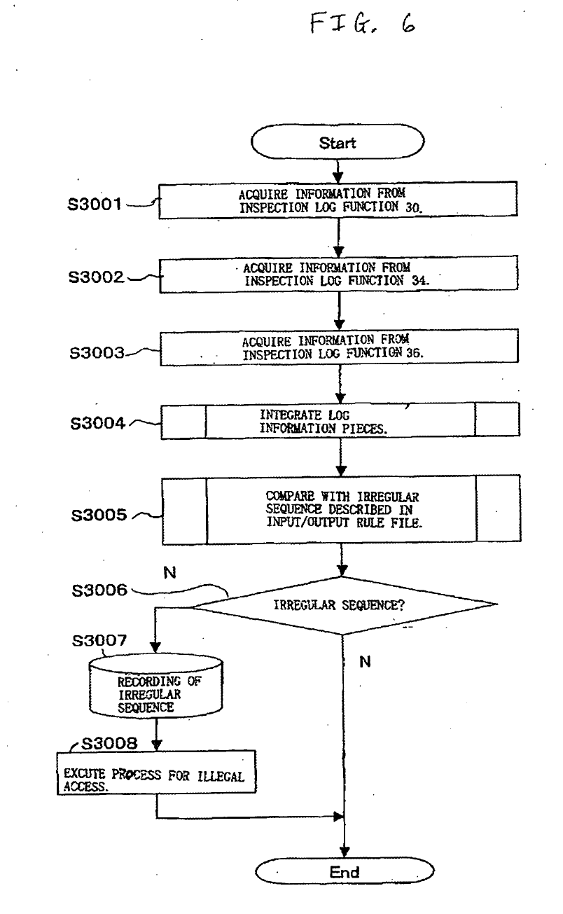

The operations conducted by the input/output supervising function 32 are described with reference to the flowchart of FIG. 6. The operations, unless otherwise specified, are conducted using the input/output supervising function 32 shown in FIG. 1. The input/output supervising function 32 acquires the log information from the supervising log functions 30, 34 and 36 (operations S3001 through S3003). These functions acquire information other than that of the inspection log function 35 that acquires the log for supervising the business applications, namely the log information for input and output. Next, the input/output supervising function 32 integrates the log information pieces acquired according to a sequence of time (operation S3004). This operation is similar to the integration operation of the application supervising function 33. Next, the input/output supervising function 32 compares the log information with irregular sequence of the input/output rule stored in the rule file 321 (operation S3005), records (operation S3007) irregular sequence upon a match (operation S3006), and outputs such irregular sequence as an unauthorized or illegal access (operation S3008).

The output may be based on printing, transmitting a notification to a terminal of administrator of the application server 1, or displaying on a display screen when a display, such as CRT, is connected with the application server 1 as in the case of the operations of the application supervising processing function 33. Moreover, according to an aspect of the present invention, countermeasures such as removal of relevant illegal request and replacement by a normal request may be implemented, in addition to output of an alarm corresponding to an irregular sequence, etc.

As described above, illegal or unauthorized access is detected by providing a function for input/output and monitoring the business applications 11 through 15 on the web container 16, integrating information pieces in the sequence of time, and detecting transition of an event (irregular sequence) in the web container 16. Accordingly, because illegal or unauthorized access is prevented as the function of the web container 16, it is no longer required to provide an individualized security procedure for each business application. Thereby, security procedures are reduced and simplified even in an environment enabling operation of business applications by a plurality of providers, and security measures that are insufficient due to lower level of security procedures for a certain business application are reduced.

Next, an exemplary application or implementation of the structure described above using a system utilizing Java™ (registered trade mark) will be discussed.

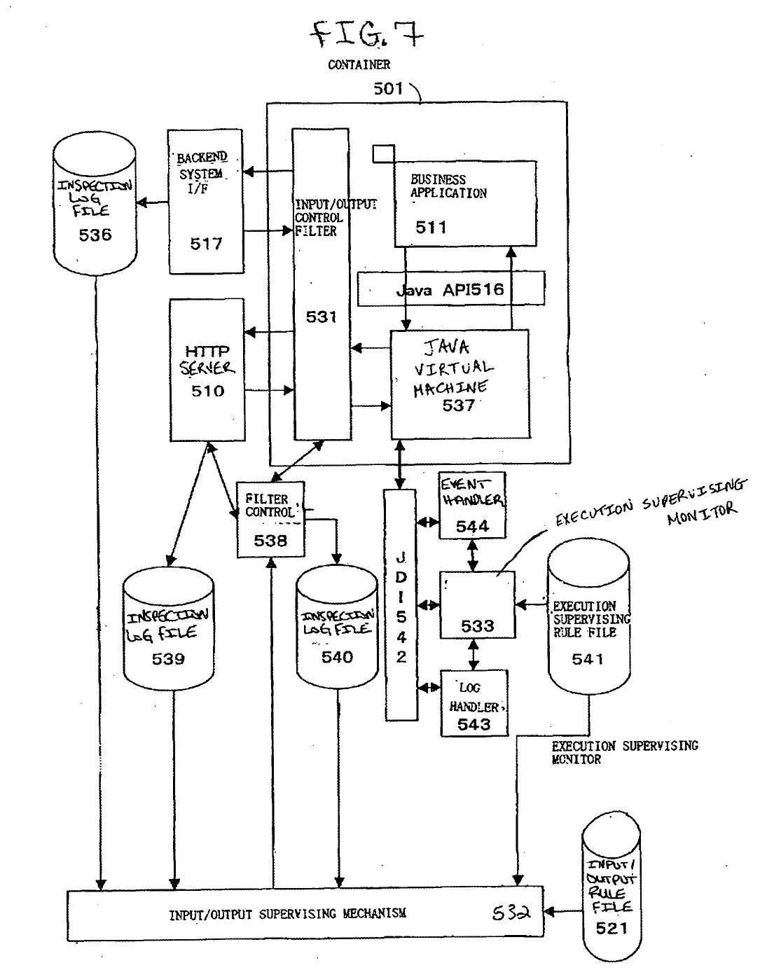

FIG. 7 illustrates a structure of an unauthorized or illegal access detection system using the Java™ (registered trade mark) system. According to an aspect of the present invention, a container 501 corresponds to the application function 4 of FIG. 1 described above. In the container 501, a Java™ (registered trade mark) virtual machine 537 is installed as a base function operating the business application 511 and the business application 511 substantially operates on the Java™ (registered trade mark) virtual machine 537. Moreover, a Java™ (registered trade mark) Debugging Interface (hereinafter referred to as JDI) 542 establishes communication with the Java™ (registered trade mark) virtual machine 537 using a protocol called the Java™ (registered trade mark) Debug Wire Protocol (hereinafter referred to as JDWP) to transfer request information, such as calling class, and also communicates with an event handler 544, a log handler 543 and an execution supervising monitor 533. The event handler 544 and log handler 543 acquire and record the information from the Java™ virtual machine 537. According to an aspect of the present invention, the execution supervising monitor (or handler) 533 corresponds to the application supervising function 33 of FIG. 1 and the execution supervising rule file 541 corresponds to the operation describing file 331 of FIG. 1 in order to integrate information pieces of the event handler 544 and log handler 543 and supervises illegal access (irregular sequence). In addition, the container 501 includes the input/output control filter 531 which enables connection and communication with the backend system interface 517 for communicating with a backend system (not shown) and the HTTP server 510 corresponding to the HTTP server 10 of FIG. 1. Moreover, a filter control function 538 is connected with both input/output control filter 531 and HTTP server 510 for filter control. The filter control function 538 records logs to the inspection log file to implement filter control. In addition, the inspection log file 539 is connected with the HTTP server 510 to record the input/output logs of the HTTP server 510. Moreover, an inspection log file 536 is similarly connected with a backend system interface 517 to record the input/output logs of the backend system interface 517. Moreover, numeral 532 denotes an input/output supervising function to acquire information from the inspection log files 536, 539 and 540, integrate the log information from each inspection log file, and execute comparison and judgment with irregular rules stored in the input/output rule file 521.

Operations in an unauthorized or illegal access preventing system using Java™ (registered trade mark) system structured as described above will be described below.

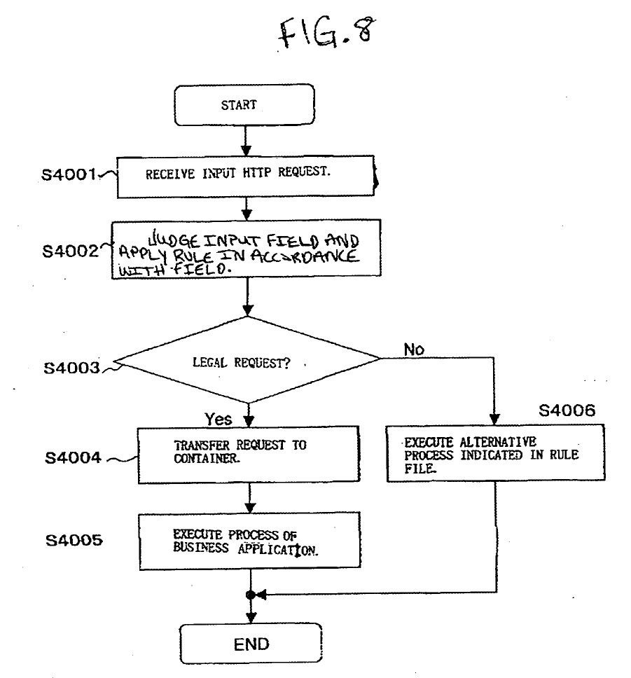

First, input/output filter control will be described with reference to FIG. 8. For this description, the operations are executed by the input/output supervising mechanism 532, unless otherwise described. First, reception of the input HTTP request by the HTTP server 510 will be described. When the HTTP server 510 receives the request information (operation S4001), a log thereof is recorded to the inspection log file 539. The input/output supervising mechanism 532 receives the recorded information and determines or judges an input field in the input HTTP request, applies the rule stored in the input/output rule file 521 (operation S4002), and determines whether the request is a normal request (operation S4003). When the request is normal, the filter control 538 controls the input/output control filter 531 to transfer the request to the container 501 (operation S4004). Accordingly, the container 501 receives the request and the business application 511 and conducts the corresponding operation (operation S4005). On the contrary, when the request is not normal in (operation S4003), an alternative operation stored in the input/output rule file 521 is executed (operation S4006).

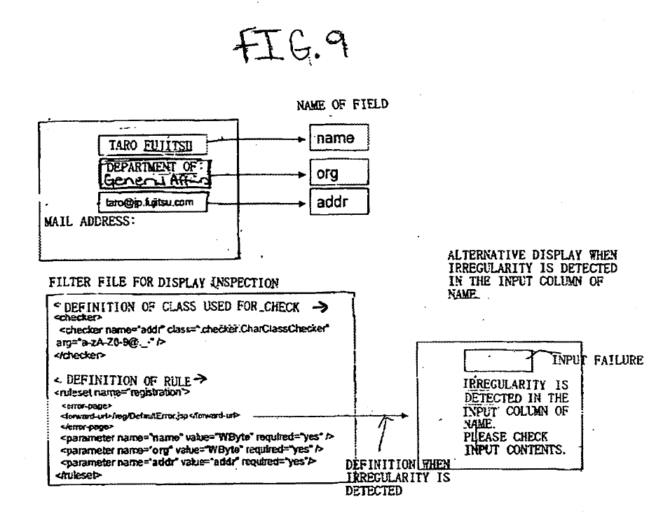

FIG. 9 illustrates an example of the alternative operation. In this example, since irregularity of an input request is detected, it is not transferred to the original request, instead an alternative operation indicating that an input is irregular is executed. Accordingly, it is possible that when irregularity in the input request is detected, illegal or unauthorized access is stopped, and an alarm for such illegal access is outputted.

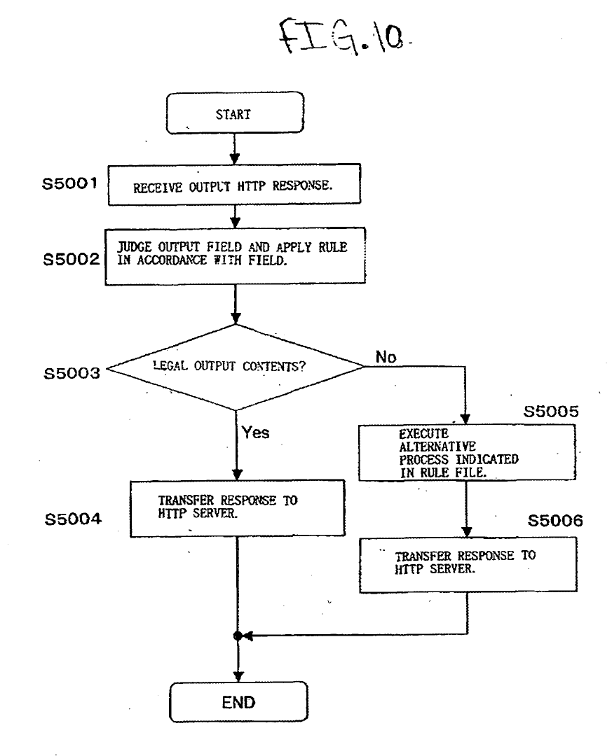

Next, detection of illegal access when the output HTTP responds, more specifically, the response to the input HTTP request outputted from the container 501 will be described with reference to the flowchart of FIG. 10. When the input/output control filter 531 receives the output response information (operation S5001), the information is recorded to the inspection log file 540. The input/output supervising mechanism 532 receives the recorded information and analyzes or judges an output field in the output HTTP response, applies the rule stored in the input/output rule file 521 (operation S5002), and determines whether the output response is normal or not (operation S5003). In this case, when the output response is normal, the HTTP server 510 receives the output response and transfers the output response to the request generating source by controlling the input/output control filter 531 (operation S5004) with the filter control 538 to transfer the request to the HTTP server 510. On the contrary, when the applied rule is determined not to be normal in the operation S5003, the alternative process stored in the input/output rule file 521 is executed (operation S5005) and the output response of the alternative process is transferred to the HTTP server 510 (operation S5006).

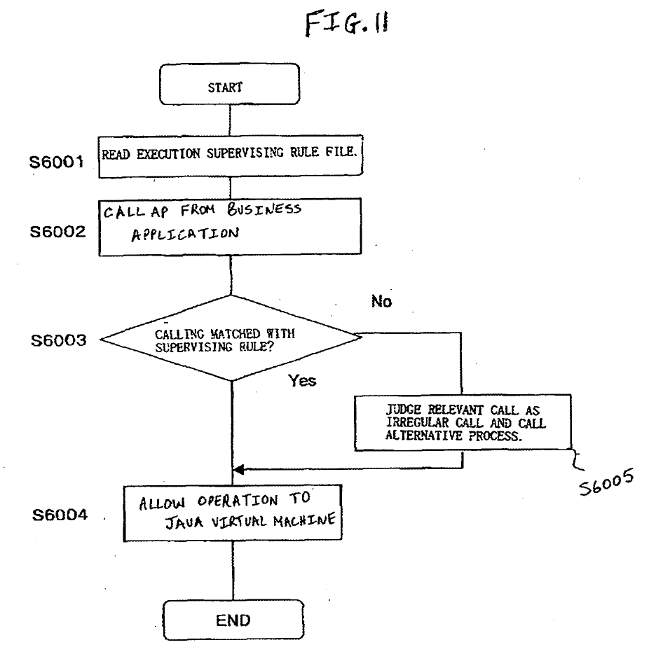

Next, the operation for supervising execution of applications using an execution supervising monitor 533 will be described with reference to the flowchart of FIG. 11. First, the execution supervising monitor 533 reads the application execution supervising rule from the execution supervising rule file 541 (operation S6001). Next, in operation S6002, the Java™ (registered trade mark) AP 1516 is called from the business application, the Java™ (registered trade mark) virtual machine 537 and transfers a message to the event handler 544 and log handler 543 via the JDI 541 shown in FIG. 7. The execution supervising monitor 533 judges whether the message matches with the stored supervising rule based on the log information received (operation S6003). When the message matches with the stored supervising rule, the present invention allows operation to be transmitted to the Java™ virtual machine at operation S6004. On the other hand, when the message does not match with the stored supervising rule, the present invention judges the call as irregular call and calls an alternative process at operation S6005.

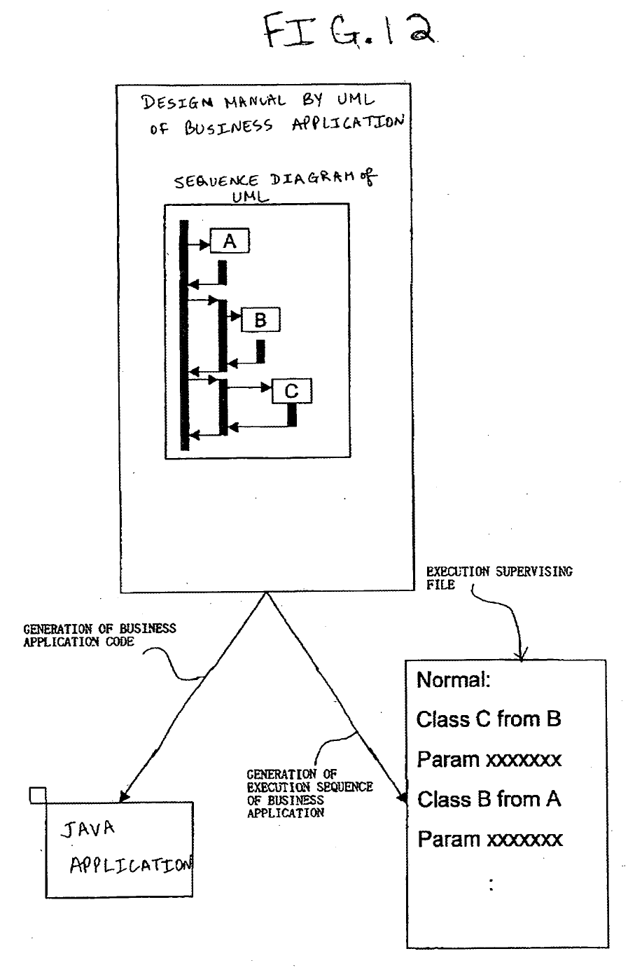

The operation of determining whether the message matches the stored supervising rule is illustrated in FIG. 12. First, a designer generates the execution supervising rule by generating the Java™ (registered trade mark) application code with reference to the design manual, such as UML of the business application, and stores the rule to the execution supervising rule file 541. The execution supervising monitor 533 reads this execution rule and determines whether this Java™ (registered trade mark) application is executed along the execution supervising rule at the time of executing the business application, more specifically, at the time of executing the Java™ (registered trade mark) application. When the applied rule matches with the supervising rule, the process is judged or determined to be normal. Accordingly, execution of the Java™ (registered trade mark) API 516 is enabled using the Java™ (registered trade mark) virtual machine 537 (operation S6004). When the applied rule does not match, on the contrary, execution of an alternative operation indicative of occurrence of irregularity is enabled using the Java™ (registered trade mark) virtual machine 537. Accordingly, the Java™ (registered trade mark) virtual machine 537 provides the Java™ (registered trade mark) API in response to a request of the business application for the normal API calling, and executes the alternative process when irregularity occurs in order to prevent an illegal or unauthorized access.

Although description of the present invention has been made using a structure of a system, the present invention is not limited to a system. For example, a computer may be used to implement each function by executing a program(s).

According to an aspect of the present invention, a computer-readable medium having stored therein an illegal access preventing program for controlling a computer having an operation describing file storing operation sequence of normal operation of business applications to implement a container function as an execution base of a plurality of business applications is provided. Further, an inspection log function is provided in the container function to acquire operation logs of the business applications, and application supervising function executes an operation in accordance with a comparison of an operation sequence of the business applications in the container function with the operation sequence-during a normal operation stored in the operation describing file with reference to the logs recorded in an inspection log function.

According to an aspect of the present invention, the illegal or unauthorized access preventing program enables the application supervising function to control the container function to execute an alternative process when the comparison result shows an irregular sequence.

According to an aspect of the present invention, the illegal or unauthorized access preventing program controls a computer to implement another inspection log function to record input/output information for the container function, and execute an operation in accordance with a comparison of the operation sequence of the business applications on the container function with the operation sequence during the normal operation stored in the operation describing file, with reference to the logs having the information of the inspection log and the second inspection log integrated in the time series.

According to an aspect of the present invention, an illegal or unauthorized access preventing program is provided and controls a computer having a rule file storing an irregular operation sequence for input and output operations to execute a container function as an execution base of a plurality of business applications. Further, the program provides an inspection log function for acquiring logs of input to and output from the container function, and an input/output supervising function for executing an operation in accordance with a comparison result by comparing the input and output operation sequence of the container function with irregular operation sequence stored in the rule file with reference to the log stored in the inspection log function.

According to an aspect of the present invention, the illegal access preventing program enables the input/output supervising function to control the container function to execute an alternative operation when the comparison result shows an irregular sequence.

According to an aspect of the present invention, an illegal access preventing system includes an operation describing file storing an operation sequence in a normal operation of an business application, a container as an execution base of a plurality of business applications, an inspection log provided to the container acquiring operation logs of the business applications, and an application supervising unit executing an operation in accordance with a comparison result by comparing, with reference to the log stored in the inspection log, the operation sequence of the business application in the container with the operation sequence during the normal operation that is stored in the operation describing file.

According to an aspect of the present invention, an illegal access preventing system includes a rule file storing irregular operation sequence for input/output operations, a container as the execution base of a plurality of business applications, an inspection log acquiring logs of input to and output from the container, and an input/output supervising unit executing a process in accordance with a comparison, with reference to the log stored in the inspection log, the input/output operation sequences of the container with the irregular operation sequence recorded in the rule file.

According to an aspect of the present invention, an illegal access preventing method for controlling a computer having an operation describing file storing an operation sequence during normal operation of business application to enable the container to function as the execution base of a plurality of business applications for acquiring operation log of business application and executing a process in accordance with a comparison result by comparing, with reference to a log recorded, the operation sequence of business application on the container function with an operation sequence during a normal operation stored in the operation describing file.

According to an aspect of the present invention, an illegal access preventing method for controlling a computer having a rule file storing irregular operation sequence for input/output operations to enable a container function as the execution base of a plurality of business applications to acquire an inspection log of input to and output from the container function, and an input/output supervising operation for executing a process in accordance with a comparison result by comparing, with reference to a log recorded in the inspection log, the input/output operation sequence of the container function with the irregular operation sequence recorded in the rule file.

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer-readable medium having an illegal access preventing program stored therein for controlling a computer having an operation describing file storing an operation sequence corresponding to normal operations of a plurality of business applications to execute operations, comprising:
implementing a container function as an execution base of the plurality of business applications;
providing an inspection log function in the container function to acquire operation logs of the business applications; and
implementing an application supervising function executing a process in accordance with a comparison resulting from comparing an operation sequence of the business applications in the container function with the operation sequence during the normal operations stored in the operation describing file with reference to the operation logs recorded in the inspection log function.

2. The illegal access preventing program according to claim 1, wherein the application supervising function controls the container function to execute a predetermined operation when the comparison indicates an irregular sequence.

3. The illegal access preventing program according to claim 1, wherein an additional inspection log function recording input/output information for the container function is provided, and the application supervising function executes the process by comparing the operation sequence of the business applications in the container function with the operation sequence during the normal operation stored in the operation describing file with reference to logs in each inspection log that is integrated in a time series.

4. An illegal access preventing program for controlling a computer having a rule file storing an irregular operation sequence of input and output operations to execute operations, comprising:
implementing a container function as an execution base of a plurality of business applications;
providing an inspection log function acquiring logs of input to and output from the container function; and
implementing an input/output supervising function executing a process in accordance with a comparison resulting from comparing an input and output operation sequence of the container function with the irregular operation sequence stored in the rule file with reference to the logs of input and output stored in the inspection log function.

5. The illegal access preventing program according to claim 4, wherein the input/output supervising function controls the container function to execute a predetermined operation when the comparison indicates an irregular sequence.

6. The illegal access preventing program according to claim 1, wherein the inspection log function acquires a log of output timing information, and the comparison includes comparing the log of output timing information with the normal operations stored in the operation describing file.

7. The illegal access preventing program according to claim 1, wherein the application supervising function sequentially integrates the operation logs of the business applications for the comparison.

8. The illegal access preventing program according to claim 1, wherein the acquired operation logs include transmission source and destination address information related to operations of the business applications.

9. The illegal access preventing program according to claim 4, wherein the inspection log function records information indicative of a log recording time, an event conducted, and an identifier of the logs of the input to and output from the container function.

10. The illegal access preventing program according to claim 4, wherein the input/output supervising function sequentially integrates the logs of the input and output of the container function for the comparison.

11. The illegal access preventing program according to claim 3, further comprising:
recording input and output logs of an HTTP server, where the comparison includes comparing the recorded input and output logs of the HTTP server with the normal operations stored in the operation describing file.

12. An apparatus for preventing an illegal access having an operation describing file storing an operation sequence corresponding to normal operations of a plurality of business applications to execute operations, comprising:
a container unit provided as an execution base of the plurality of business applications;
an inspection log unit provided to the container unit to acquire operation logs of the business applications; and
an application supervising unit executing a process in accordance with a comparison resulting from comparing an operation sequence of the business applications in the container function with the operation sequence during the normal operations stored in the operation describing file with reference to the operation logs recorded in the inspection log function.

13. A method of controlling access to an application server having a plurality of business applications, comprising:
storing operation sequences of normal operations of the business applications; and
enabling an access to the application server upon determining that an operation log of at least one of the business applications matches one of the stored operation sequences.

14. The method of controlling access according to claim 13, wherein the application server exchanges information using a hyper text transfer protocol and/or a hyper text transfer protocol security.

15. The method of controlling access according to claim 13, further comprising:
executing a predetermined operation when the operation log of the at least one of the business applications does not match the stored operation sequences.

16. A method of authorizing an access to an application server storing business applications and connected with a network, comprising:
determining whether an input field of an HTTP request corresponds to predetermined data in a rule file; and
authorizing an access to the application server when the input field of the HTTP request matches the predetermined data in the rule file.

17. The method of authorizing an access according to 16, wherein a notification is transmitted to an administrator of the application server when the input field of the HTTP request does not match with the predetermined data in the rule file.

18. A system for detecting an unauthorized access to an application server having multiple business applications, comprising:
a storage unit storing an operation describing file having respective operation sequences of normal operations of the multiple business applications; and
an application supervising unit determining whether an operation sequence in an operation log of any one of the business applications matches a respective operation sequence in the operation describing file to detect the unauthorized access.

19. The system for detecting an unauthorized access according to claim 18, wherein the application server includes an HTTP server that monitors information exchanged via the application server.

20. An apparatus for detecting an unauthorized access to an application server having multiple business applications, comprising:
means for storing an operation describing file having respective operation sequences of normal operations of the multiple business applications; and
means for determining whether an operation sequence in an operation log of any one of the business applications matches a respective operation sequence in the operation describing file to detect the unauthorized access.
